(19) United States
(12) Patent Application Publication
(10) Pub. No.: US 2007/0085982 A1
(43) Pub. Date: Apr. 19, 2007

(54) Integrator device

(76) Inventors: Kuohua Wu, Corvallis, OR (US); P. Guy Howard, Junction City, OR (US); Kevin Hulick, Corvallis, OR (US); Michael D. Long, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/253,846

(22) Filed: Oct. 18, 2005

(51) Int. Cl. G03B 21/00

(52) U.S. Cl. 353/122; 385/901

(57) ABSTRACT

An integrator device is provided in the present disclosure. The integrator device may be used in a display system. According to one exemplary embodiment, the integrator device includes at least one metallic substrate. An anti-reflective layer is formed on the substrate. In addition, a band-reject layer formed is on said anti-reflective layer.

### BACKGROUND

Digital projectors, such as digital mirror devices (DMD) and liquid crystal display (LCD) projectors, project high-quality images onto a viewing surface. Both DMD and LCD projectors utilize high-intensity lamps and reflectors to generate the light needed for projection. Light generated by the lamp is concentrated as a “fireball,” which is located at a focal point of a reflector. Light produced by the fireball is directed into a projection assembly that produces images and utilizes the generated light to form the image. The image is then projected onto a viewing surface.

Efforts have been directed at making projectors more compact while making the image of higher and better quality. As a result, the lamps utilized have become more compact and of higher intensity. This high-intensity light is directed toward the display optics. On occasion, if the high-intensity light is conveyed directly to the projection assembly, areas of higher intensity light will appear. In order to provide more uniform light across the projection assembly, integrating devices are frequently used to spatially homogenize the light. For example, some integrating devices make use of a tunnel with a reflective treatment applied to the interior surfaces. As light enters the integrating tunnel, the light is bounced between the surfaces. The resulting reflections from within the integrating tunnel reduces the localized concentration of the exiting light, Thus, as the light exits the integrating tunnel, the light is more spatially homogenous. However, in many cases, each time the light is incident on a surface, up to 10 percent or more of the light is absorbed.

### SUMMARY

An integrator device is provided in the present disclosure. The integrator device may be used in a display system. According to one exemplary embodiment, the integrator device includes at least one metallic substrate. An anti-reflective layer is formed on the substrate. In addition, a band-reject layer formed is on said anti-reflective layer.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a display system according to one exemplary embodiment.

FIG. 2 illustrates a perspective view of an integrator device according to one exemplary embodiment.

FIG. 3 is a partial cross sectional view of one side of an integrated unit according to one exemplary embodiment.

FIG. 4 is a partial cross sectional view of one side of an integrated unit according to one exemplary embodiment.

FIG. 5 is a method of forming an integrator device according to one exemplary embodiment.

Throughout the drawings, identical reference numbers designate similar, but not necessarily identical, elements.

### DETAILED DESCRIPTION

Integrator devices are provided herein for use in display systems. In particular, integrating devices spatially homogenize light generated by a light source module. Spatial homogenization of the light may increase the uniformity of light directed to a light modulator assembly. Further, spatial homogenization of the light may eventually increase the quality of an image produced by the display system. According to one exemplary embodiment, an integrating device includes a plurality of metallic substrates with thin-film coatings applied thereto. The thin films include a band-reject filter and an anti-reflective coating. The band-reject filter reflects light in the visible spectrum while allowing electromagnetic radiation outside the visible spectrum to pass therethrough. The anti-reflective coating absorbs the passed-through electromagnetic radiation and directs it to the metal substrates. The metal substrates then convert a substantial portion of this electromagnetic radiation to thermal energy, which is then removed through convective cooling. Thus, the integrator device is configured to reflect a relatively high portion of visible light directed thereto while absorbing a substantial portion of radiation outside the visible spectrum. Such a configuration may allow for more efficient cooling of the display system.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

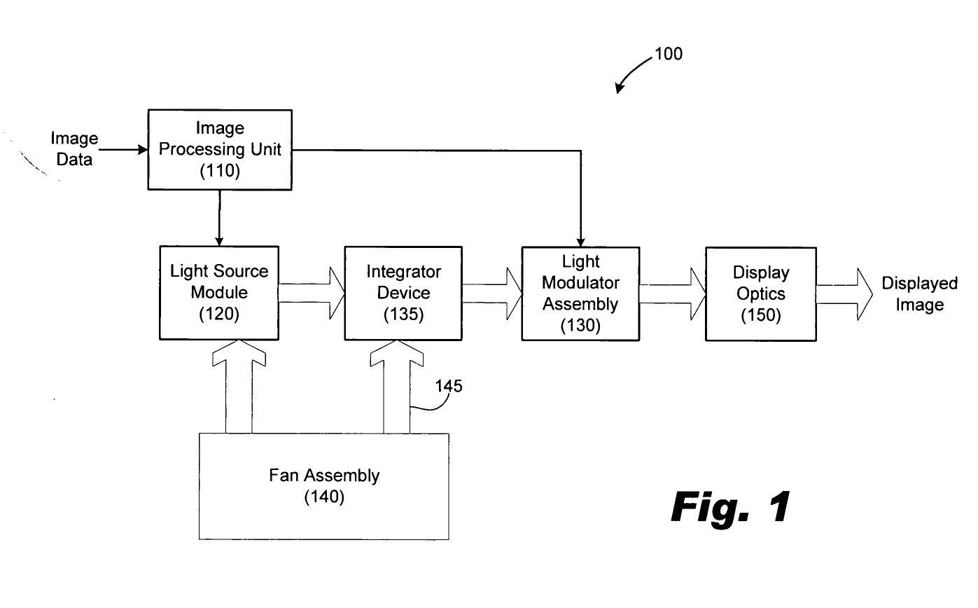

FIG. 1 illustrates an exemplary display system (100). The components of FIG. 1 are exemplary only and may be modified or changed as best serves a particular application. As shown in FIG. 1, image data is input into an image processing unit (110). The image data defines an image that is to be displayed by the display system (100). While one image is illustrated and described as being processed by the image processing unit (110), it will be understood by one skilled in the art that a plurality or series of images may be processed by the image processing unit (110). The image processing unit (110) performs various functions including controlling the illumination of a light source module (120) and controlling a light modulator assembly (130).

The light source module (120) generates light in the visible spectrum for use by the display system (100). In addition to generating light in the visible spectrum, the light source module (120) also generates light outside the visible spectrum, including ultraviolet and infrared light. This non-visible light is directed to an integrator device (135). The integrator device (135), according to one exemplary embodiment, is configured to reflect light in the visible spectrum and absorb radiation outside the visible spectrum. In particular, according to one exemplary embodiment, the integrator device (135) includes a band-reject filter layer that reflects light in the visible spectrum and passes the light outside the visible spectrum to an anti-reflective coating. The anti-reflective coating absorbs the non-visible light. The absorbed non-visible light is transmitted to the metal substrate.

The display system (100), according to the present exemplary embodiment, also includes a fan assembly (140). The fan assembly (140) directs an airflow (145) toward the light modulator assembly (130) and/or the integrator device (135). While a single airflow (145) will be discussed herein, those of skill in the art will appreciate that any number of airflows may be directed to the light source module (120) and/or the integrator device (135). For ease of reference, the fan assembly (140) will be discussed as providing airflow (145) to both the light modulator assembly (130) and the integrator device (135).

As introduced, in addition to generating light in the visible spectrum, the light source module (120) generates heat and non-visible light. A portion of this heat is absorbed by the light source module (120). As the airflow (145) passes over the light source module (120), the airflow (145) convectively cools the light source module (120). According to one exemplary embodiment, a substantial portion of the non-visible light generated by the light source module (120) may be conveyed to the integrator device (135).

A substantial portion of the non-visible light directed to the integrator device (135) is absorbed. The absorbed non-visible light is conveyed to an outer surface of the integrator device (135). As the energy associated with the non-visible light reaches the outer surface of the integrator device (135), the temperature of the outer surface may be elevated.

As the airflow (145) passes over the heated outer surface of the integrator device (135), the airflow (145) convectively cools the heated outer surface of the integrator device (135). Thus, a substantial portion of the energy associated with the non-visible light produced by the light source module (120) may be dissipated from the integrator device (135). Accordingly, a substantial portion of the heat and non-visible light produced by the light source module (120) is removed from the light source module (120) and the integrator device (135) by the airflow (145). The absorption of this non-visible light may reduce or minimize the use of infrared and/or ultraviolet filters located in the optical path. The decreased use of such filters may reduce the number of fans used to maintain a suitable operating temperature in the components in the optical path. Further, the decreased use of such filters may increase throughput of visible light. In particular, over time ultraviolet and/or infrared filters may be subject to clouding due to heating. This clouding may reduce the throughput of the visible light produced by the light source module (120). According to the present exemplary embodiment, a substantial portion of the visible light is transmitted out of the integrator device (135) while the non-visible radiation is absorbed by the integrator device (135).

The light exiting the integrator device (135) is then directed to the light modulator assembly (130). The incident light may be modulated in its color, phase, intensity, polarization, or direction by the light modulator assembly (130). Thus, the light modulator assembly (130) of FIG. 1 modulates the light based on input from the image processing unit (110) to form an image-bearing beam of light that is eventually displayed or cast by display optics (150) onto a viewing surface (not shown).

The display optics (150) may include any device configured to display or project an image. For example, the display optics (150) may be, but are not limited to, a lens configured to project and focus an image onto a viewing surface. The viewing surface may be, but is not limited to, a screen, television, wall, liquid crystal display (LCD), or computer monitor.

Integrator Device

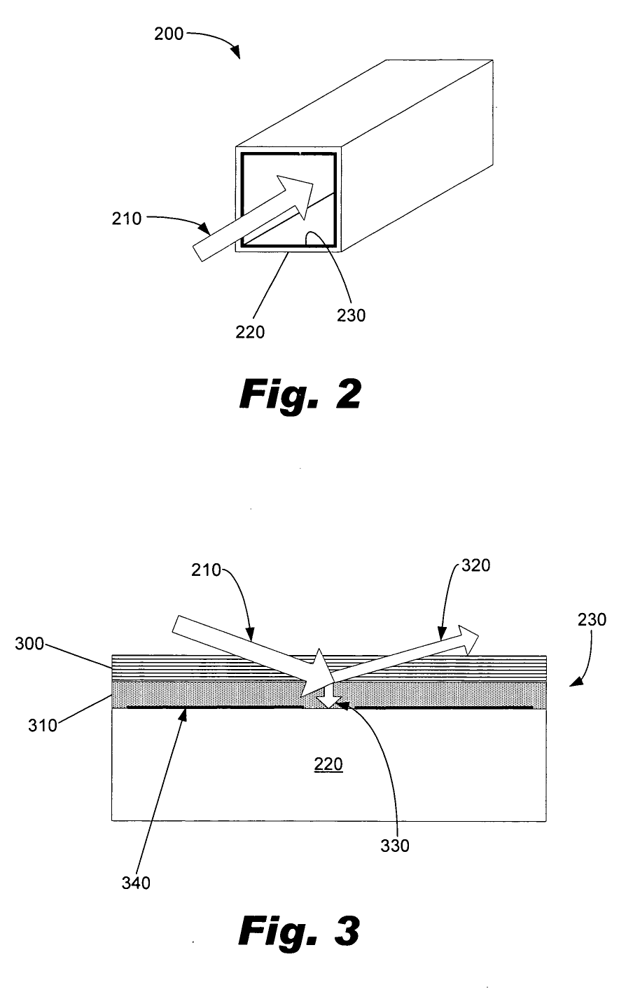

FIG. 2 illustrates a perspective view of an integrator device (200) according to one exemplary embodiment. A beam of light (210) is shown entering the integrator device (200), such as from a light source module (120; FIG. 1) as described above. Further, as previously discussed, the beam of light (210) may include light within the visible spectrum as well as infrared and/or ultraviolet light.

The integrator device (200), according to the present exemplary embodiment, has a generally rectilinear perimeter formed by four metallic substrates (220). While a generally rectilinear perimeter or cross section is described herein, those of skill in the art will appreciate that other shapes are contemplated. For example, the integrator device (200) may have other cross sectional profiles. In particular, according to one exemplary embodiment, the integrator device (200) may have a generally hollow cylindrical shape such that the perimeter has a circular profile. Further, while the integrator device (200) illustrated has a constant cross sectional area along the length thereof, those of skill in the art will appreciate that the cross section of the integrator device may vary along the length thereof.

Returning to FIG. 2, the integrator device (200), according to the present exemplary embodiment includes, four metallic substrates (220). The metallic substrates (220) may be mechanically joined. For example, according to one exemplary embodiment, the metallic substrates may be joined together by welding. A welded joint may allow the integrator device (200) to maintain a stable shape at elevated temperatures. In particular, a welded joint may be less susceptible to degradation at elevated temperatures than a joint formed exclusively by adhesives. Each of the metallic substrates (220) has a reflective coating (230) applied thereto. The reflective coating (230) selectively reflects a substantial portion of the light (210) in the visible spectrum while transmitting a substantial portion of the light in the non-visible spectrum. The reflective coating (230) also includes an anti-reflective component that absorbs the non-visible light. The anti-reflective component then transmits the light to the metallic substrates (220). An exemplary coating (230) will be discussed in more detail below.

Exemplary Band-Reject Coating

FIG. 3 illustrates a partial cross-sectional view of one of the metallic substrates (220), which shows the reflective coating (230) in more detail. As shown in FIG. 3, the reflective coating (230) shown includes a band-reject layer (300) and an anti-reflective or non-visible light-absorbing layer (310). As will be discussed in more detail below, the band-reject layer (300) reflects a substantial portion of the visible portion of the light (210) that has an angle of incidence of between about 40-85 degrees.

The reflected light (320) is directed away from the reflective coating (230) and toward the exit of the integrator device (200; FIG. 2). The band-reject layer (300) transmits the non-visible light (330) to the anti-reflective layer (310). The anti-reflective layer (310) absorbs the non-visible light (330) and converts it to thermal energy. The thermal energy is then transmitted to the metallic substrate (220). The thermal energy may then be dissipated, such as through forced convection.

The reflective coating (230), according to the present exemplary embodiment, may have a thickness in the quarter-wave range due to the incidence angle of light directed thereto. Such light may generally have an angle of incidence of between about 40-85 degrees, such as an angle of incidence of about 50-80 degrees. The band-reject layer (300), according to one exemplary embodiment, includes several alternating dielectric layers. The band-reject layers reflect light with angles of incidence within these ranges while transmitting light outside of the visible spectrum. While an all-dielectric band-reject filter is discussed herein, those of skill in the art will appreciate that any type of band-reject may be used that reflects light in the visible spectrum while transmitting IR and/or UV radiation. Other suitable band-reject filters include, without limitation, metal-dielectric type band-reject filters.

According to the present exemplary embodiment, the all-dielectric band-reject filter includes several layers of dielectric materials. The layers of dielectrics layers include alternating layers of materials with high and low indices of refraction (indices). Suitable dielectric materials may include, without limitation, TiO₂, SiO₂, Ta₂O₃, or Al₂O₃. According to one exemplary embodiment, the band-reject layer (300) reflects greater than about 95 percent of the visible light while transmitting a substantial portion of the non-visible light (330). Further, the thickness and number of alternating materials is selected to reject visible light with an angle of incidence of between about 40-85 degrees, such as angles of incidence of between about 50-80 degrees while non-visible light (330) is transmitted.

The non-visible light (330) is transmitted to the anti-reflective layer (310). The anti-reflective layer (310) may include several layers of IR anti-reflective matching layers and/or several layers of UV anti-reflective matching layers. The anti-reflective matching layers provide low reflectance for a substantial portion of the infrared and ultraviolet regions. The anti-reflective matching layers include multiple layers of dielectric, metal, or semi-metal thin film materials. Such materials may include, without limitation, W, Ni, Ti, Ta, Al₂O₃, Cr₂O₃, and SiO₂. The combination of these materials allows the anti-reflective layer (310) to absorb a substantial portion of the non-visible light (330) directed thereto. Further, individual layers of metallic materials are formed within the anti-reflective layer (310).

The materials used in the anti-reflective layer (310) may be selected to act as thermal expansion absorbers. For example, as introduced, multiple layers are deposited to form a thin film with a thickness in the quarter-wave thickness range that is directly formed on the metallic substrate (220). As the non-visible light (330) is absorbed, the anti-reflective layer (310) is heated. Metallic strips (340) may be included in the anti-reflective layer (310). The metallic strips absorb heat. As the metallic strips absorb heat, they expand relative to the rest of the anti-reflective layer (310). This isolated expansion of the metallic strips relative to the rest of the anti-reflective layer (310) may reduce thermal stresses between in the anti-reflective layer (310), the metallic substrate (310), and the band-reject layer (300). Thus, the materials used in the anti-reflective layer (310) may be selected to act as thermal expansion absorbers.

The anti-reflective layer (310) is intimate contact with the metallic substrate (220). As a result, radiation absorbed by the anti-reflective layer (310) may be transmitted through to the inner surface of the metallic substrate (220). The radiation absorbed by the inner surface of the metallic substrate (220) then travels through the metallic substrate (220) to the outer surface. According to one exemplary embodiment, upon reaching the outer surface of the substrate (220), the radiation heats up the outer surface.

As the radiation heats up the outer surface, an airflow (145; FIG. 1) directed thereto cools the outer surface. The heat transfer rate from the outer surface may be calculated by the following equation:
Convection=hAΔT
where h is an empirically calculated number that is a function of geometry and airflow, A is the surface area taking part in convection, and ΔT is the difference in temperature between the surface and the ambient temperature. Thus, for a given airflow over a surface with a fixed area, dissipation of energy through convective cooling may be increased by increasing the temperature of the surface. As a result, as the radiation associated with the absorbed non-visible light 330) heats the outer surface of the metallic substrate (220), the higher temperature increases the heat dissipated through convective cooling by the airflow (145; FIG. 1).

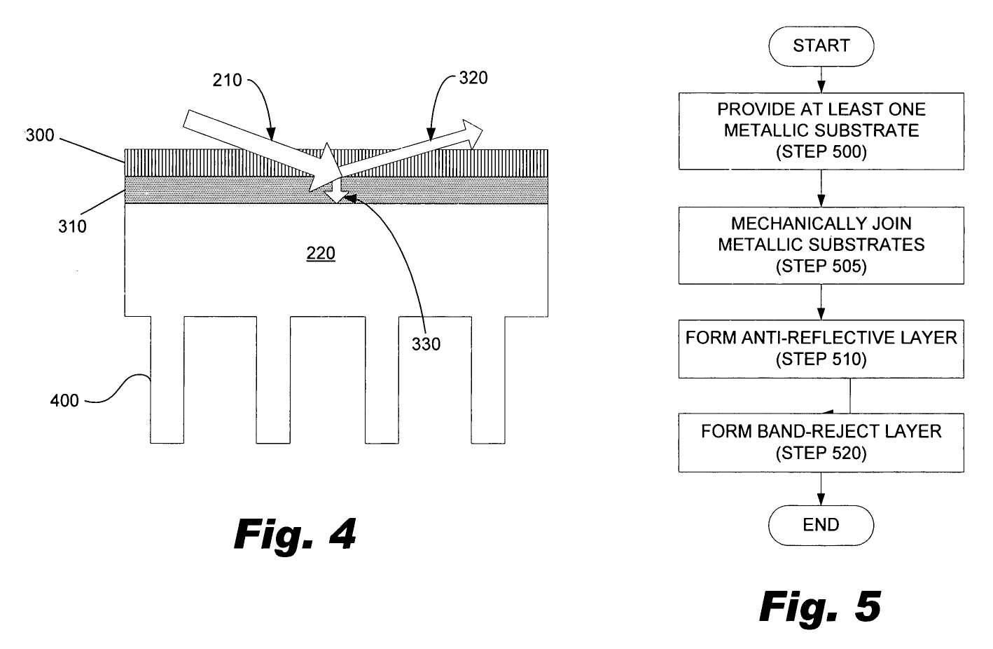

Further, in addition to increasing the temperature of the outer surface, the surface area taking part in convection may also be increased. In particular, FIG. 4, illustrates a partial cross-sectional view of an integrator device wherein the outer surface of the metallic substrate (220) includes elongated cooling fins (400).

Method of Forming an Integrator Device

FIG. 5 is a flowchart illustrating a method of forming an integrator device according to one exemplary embodiment. The method begins by providing at least one metallic substrate (step 500). One exemplary method includes providing at least one substrate formed of aluminum, zinc, magnesium, brass, and/or copper. Those of skill in the art will appreciate that any other suitable metallic substrate(s) may also be used.

According to one exemplary embodiment, providing at least one metallic substrate includes providing a plurality of substrates. These substrates are then joined (step 505). For example, according to one exemplary embodiment the substrates are joined mechanically, such as by welding.

Thereafter, an anti-reflective layer is deposited on the aluminum substrate (step 510). According to one exemplary method, deposition of the anti-reflective layer includes depositing an anti-reflective layer including both UV-absorbing material and IR-absorbing material. Such materials may be deposited onto the substrate through a chemical vapor deposition process, or any other suitable process.

A band-reject layer is then applied (step 520). The band-reject layer is configured to reflect a substantial portion of light in the visible spectrum while transmitting light outside the visible spectrum. According to one exemplary method, alternating layers of materials with high indices of refraction and low indices of refraction are deposited. These alternating layers may be deposited using the same process described above, such as chemical vapor deposition. Such a process may reduce contamination associated with the use of multiple coating machines. Further, such a process may be relatively simple, thereby reducing the cost associated with forming an integrator device. The number and thickness of each layer is selected to reflect light in the visible spectrum with an angle of incidence of between about 40-85 degrees, such as angles of incidence of about 50-80 degrees.

Integrator devices are provided herein for use in display systems. In particular, integrating devices spatially homogenize light generated by a light source module. Spatial homogenization of the light may increase the uniformity of light directed to a light modulator assembly. Further, spatial homogenization of the light may eventually increase the quality of an image produced by the display system. According to one exemplary embodiment, an integrating device includes a plurality of metallic substrates with thin-film coatings applied thereto. The thin films include a band-reject filter and an anti-reflective coating. The band-reject filter reflects light in the visible spectrum while allowing electromagnetic radiation outside the visible spectrum to pass therethrough. The anti-reflective coating absorbs this electromagnetic radiation and directs it to the metal substrates. The metal substrates then convert a substantial portion of this electromagnetic radiation to thermal energy, which is then removed through convective cooling. Thus, integrator device is configured to reflect a relatively high portion of visible light directed thereto while absorbing a substantial portion of radiation outside the visible spectrum. Such a configuration may allow for more efficient cooling of the display system.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. An integrator device, comprising:
at least one metallic substrate;
an anti-reflective layer formed on said substrate; and
a band-reject layer formed on said anti-reflective layer, said band-reject layer being configured to reflect visible light with an angle of incidence of between about 40-85 degrees.

2. The device of claim 1, wherein said metallic substrate comprises at least one of aluminum, zinc, magnesium, brass, and/or copper.

3. The device of claim 1, wherein said band-reject layer is an all-dielectric type band-reject layer.

4. The device of claim 3, wherein said all-dielectric type band-reject layer includes alternating layers of materials having high indices of refraction and low indices of refraction.

5. The device of claim 3, wherein said all-dielectric type band-reject layer includes at least two of TiO₂, SiO₂, Ta₂O₃, and Al₂O₃.

6. The device of claim 1, wherein said anti-reflective coating includes at least one anti-reflective matched absorbing layer.

7. The device of claim 6, wherein said anti-reflective matched absorbing layer includes at least one of W, Ni, Ti, Ta, Al₂O₃, Cr₂O₃, and SiO₂.

8. The device of claim 1, wherein said metallic substrate includes a plurality of cooling fins formed thereon.

9. The device of claim 1, and further comprising a plurality of metallic substrates.

10. The device of claim 9, wherein said plurality of metallic substrates define a tunnel with a generally rectangular cross section.

11. The device of claim 9, wherein said metallic substrates are mechanically joined.

12. The device of claim 11, wherein said metallic substrates are welded together.

13. The device of claim 1, wherein said band-reject layer is configured to reflect visible light with an angle of incidence of between about 50-80 degrees.

14. The device of claim 1, wherein said anti-reflective layer includes at least one thermal expansion absorber.

15. The device of claim 14, wherein said thermal expansion absorber comprises metallic strips.

16. A display system, comprising:
a light source module;
an integrator device in optical communication with said light source module, said integrator device being configured to selectively reflect light in a visible spectrum with an angle of incidence of about 40-85 degrees from said light source module and absorb light outside said visible spectrum; and
a light modulator assembly in optical communication with said integrator device.

17. The system of claim 16, and further comprising a fan assembly configured to direct an airflow to said integrator device.

18. The system of claim 17, wherein said fan assembly is configured to direct an airflow to said light source module.

19. The system of claim 16, wherein said integrator device includes a metallic substrate, an band-reject layer, and an anti-reflective layer.

20. The system of claim 19, wherein said metallic reflector includes a plurality of elongated cooling fins formed thereon.

21. A method of forming an integrator device, comprising:
providing at least one metallic substrate;
forming an anti-reflective layer on said metallic substrate; and
forming a band-reject layer on said anti-reflective layer, said band-reject layer being configured to reflect visible light with an angle of incidence of between about 40-85 degrees.

22. The method of claim 21, wherein forming said anti-reflective layer includes forming at least one layer of an IR absorbing material.

23. The method of claim 21, wherein forming said anti-reflective layer includes chemical vapor deposition.

24. The method of claim 23, wherein forming said band-reject layer includes said chemical vapor deposition.

25. The method of claim 24, wherein said anti-reflective layer and said band-reject layer are formed by a same process.

26. The method of claim 21, wherein forming a band-reject filter includes forming alternating layers of at least one material with a high index of refraction and at least one material with a low index of refraction.

27. The method of claim 25, wherein forming said alternating layers includes forming all-dielectric layers.

28. The method of claim 21, further comprising providing a plurality of metallic substrates and mechanically joining said metallic substrates.

29. The method of claim 28, wherein mechanically joining said metallic substrates includes welding said metallic substrates.

30. An integrator device, comprising:
a metallic substrate;
means for absorbing non-visible light in intimate contact with said metallic substrate; and
means for reflecting visible light in intimate contact with said means for absorbing non-visible light.

31. The integrator device of claim 30, and further comprising means for increasing an area of said metallic substrate.
